(19) United States
(12) Patent Application Publication
(10) Pub. No.: US 2019/0218371 A1
(43) Pub. Date: Jul. 18, 2019

(54) PLASTICS CONTAINING TORREFIED BIOMASS ADDITIVES

(71) Applicant: The United States of America, as Represented by the Secretary of Agriculture, Washington, DC (US)

(72) Inventors: Bor Sen Chiou, Albany, CA (US); Lennard F. Torres, Dublin, CA (US); Zachariah McCaffrey, Davis, CA (US); William J. Orts, Burlingame, CA (US)

(21) Appl. No.: 16/249,780

(22) Filed: Jan. 16, 2019

Related U.S. Application Data
(60) Provisional application No. 62/618,298, filed on Jan. 17, 2018.

(51) Int. Cl. C08K 11/00

(52) U.S. Cl. CPC C08K 11/005; C08K 2201/005

(57) ABSTRACT

Plastics (e.g., virgin or recycled or reclaimed) are combined with torrefied biomass to create a composite with surprisingly high heat deflection, good mechanical and barrier properties. The composite provides an alternative to conventional composites which contain industrial additives, fillers, and colorants. The torrefied biomass replaces conventional industrial additives and also provides improvement to diminished properties of recycled or reclaimed plastics. The composites described herein can be incorporated into a variety of end products such as cutlery, containers for packaging, hot server items, hard plastic casings, 3-D printed items, and other items.

### REFERENCE TO RELATED APPLICATION

This application claims the benefit of U.S. Provisional Application No. 62/618,298, filed 17 Jan. 2018, which is incorporated herein by reference in its entirety.

### FIELD OF THE INVENTION

The disclosed methods and compositions relate to polymer composite compositions containing a mixture of (a) plastics (e.g., virgin, recycled or reclaimed plastics) and (b) torrefied biomass filler.

### BACKGROUND OF THE INVENTION

Polypropylene (PP) is a commodity plastic commonly used in a wide array of applications, such as automotive interior parts, clothing, low density packaging, and structural foam because of its toughness and good chemical resistance. However, such widespread use of PP has created a problem relating to the disposal of the thermoplastic. Single use products made of PP end up in landfills as waste. Because PP degrades slowly in landfills, waste management has become a significant issue. Fortunately, polypropylene, in addition to other plastics such as polyethylene terephthalate (PET), polystyrene (PS), and polyethylene (PE), can be recycled, and most communities engage in some form of active recycling programs.

There are several available methods for recycling plastics. One method involves homogenous recycling, as disclosed in U.S. Pat. Nos. 3,567,815 and 3,976,730. In U.S. Pat. No. 3,567,815, approximately 5-30% high density polystyrene was melt-blended to post-consumer low density polystyrene to improve its processability. Addition of small quantities of high density polystyrene produced unusually large increases in extrusion rate and relatively uniform thickness gauge on the sheet extrudate. In U.S. Pat. No. 3,976,730, a method was presented in which melt scrap polyethylene was melt-blended into virgin resin at concentrations of 20 to 40%. Another method as described in U.S. Pat. No. 5,145,617 involved mixing different plastics. The common theme described in these patents—a process known in the art as reclamation—is that the plastic waste materials are being recycled in the form of blends via various polymer processes such as extrusion. The method allows for the conversion of the plastic waste materials into a variety of new materials. However, reclamation often produces materials with reduced mechanical and thermal properties. This is loosely termed “down cycling” the plastic rather than “recycling” and it affects the end-use value of the reclaimed product.

To improve or broaden the range of properties of the reclaimed materials, certain additives are melt-blended via extrusion into recycled plastics. These additives typically include glass fibers, calcium carbonate, and elastomers (e.g., natural rubber). For example, glass fiber-filled composites have high stiffness, good weight-to-strength ratio, and high impact strength which make them ideal for interior as well as exterior automotive parts. Talc powder, a commonly used industrial filler, can also increase stiffness and mechanical strength of reclaimed plastics. It can also displace the cost of adding virgin material to recycled plastics. Other additives such as carbon black, talc, and titanium dioxide are also used; however, they are typically added as colorants and offer very little improvement to the mechanical properties of recycled plastics.

Due to growing public concern for the reduction of greenhouse gases, industry has focused on the utilization of biomass (e.g., forest trimmings, farming residues and agricultural wastes, animal byproducts, food waste, etc.) as additives for recycled plastics. Biomass reinforced plastic composites have been developed for many applications mainly because the biomass is derived from sustainable, natural resources and therefore can reduce greenhouse gas emissions considerably. Moreover, handling of biomass yields less health and safety hazards and produces much less wear on processing equipment, unlike, for example, glass fiber-filled recycled plastic composites. One disadvantage of the use of biomass as additives for composites is the hydrophilic nature of the materials. Biomass mainly contains hemicellulose, amorphous and crystalline cellulose, lignin, and, to some extent, volatile organic acids and oils. The hydrophilic nature of the hemicellulose and amorphous cellulose components makes the biomass incompatible with hydrophobic recycled plastics, resulting in poor interfacial adhesion between the natural fibers and the polymer matrix. Another disadvantage is the poor thermal properties of the biomass which can degrade during melt-blending with plastics. Without pretreatment, the processing temperatures of the plastics can lead to degradation of the main components of the biomass, which negatively affects the structural integrity of the resulting biocomposite. Finally, to some extent, off-gassing (i.e., elimination of volatile materials) may also occur which can be problematic during production.

Beyond niche markets, biomass filler has broader potential market appeal in durable goods such as automotive parts and household wares. However, it is difficult for unmodified biomass to be used for high performance applications due to its inherent hydrophilic nature and poor thermal resistance. Efforts have been made in the industry to improve these properties. For example, compatibilizers (e.g., polypropylene-graft-maleic anhydride) are melt blended with biomass additives to improve interfacial adhesion of the biomass to the hydrophobic recycled plastics. However, this is not cost-effective and the resulting effect on the bulk properties of the recycled polymer are nominal at best. Moreover, it does not address the growing public concern of the composite's environmental impact.

Thus there exists an industrial need to improve the material properties of biomass to broaden potential market applications as an environmentally-friendly, sustainable filler. In particular, there is a need for adding more functionality to biomass additives to improve the mechanical and thermal properties of virgin, reclaimed or recycled plastics. The improvements described herein will allow biomass additives to be melt-blended into plastics (e.g., virgin, recycled or reclaimed plastics) at elevated temperatures (e.g., about 200° to about 300° C.) to produce not only single-use products but also high performance, durable goods for applications, for example, in the automotive and food industries.

### SUMMARY OF THE INVENTION

The present disclosure accordingly provides a polymer composite having commercially viable properties as described herein. In one aspect, the disclosure pertains to a biomass filler subjected to a pretreatment known as torrefaction which improves its adhesion to recycled or reclaimed plastics without the need of petroleum-based industrial compatibilizers. Specifically, the disclosure provides a polymer composite with improved mechanical, thermal, and barrier properties.

It is one advantage of the disclosure to provide biomass additives having a synergistic effect with plastics (e.g., virgin, recycled or reclaimed plastics) resulting in a composite with commercially favorable mechanical, thermal, and barrier properties as described herein.

It is an additional advantage of the disclosure to provide polymer composites with tunable, tailored mechanical properties (e.g., flexural modulus and strength), and improved thermal (e.g., heat deflection temperature) and barrier properties through optimization of particle size, particle shape, moisture level and heating time.

It is a further advantage of this disclosure to fill an industrial need by providing environmentally-friendly, sustainable fillers that allow for wide-use application of plastics (e.g., virgin, recycled or reclaimed plastics) in an array of commercial products.

It is another advantage of the present disclosure to provide novel technologies for improved composites in commercial applications, including food packaging, durable goods, single-use products, among others.

It is yet another advantage of the present disclosure to provide an array of applications to add flexibility to commercial biorefinery operations via value-added co-products from agriculturally-derived feedstocks.

Disclosed are composites containing (a) plastics (e.g., virgin, recycled or reclaimed plastics) and (b) torrefied biomass, wherein the plastics and the torrefied biomass are compounded to create a composite.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the thermogravimetric analyses (TGA) data of unmodified (non-torrefied) almond shells torrefied at 4 different temperatures as described below: 200°, 230°, 260°, and 300° C.

FIG. 2 shows the Fourier-transform infrared spectroscopy (FT-IR) spectra data of the torrefied biomass as described below.

FIG. 3 shows flexural modulus of torrefied sorghum biocomposites in polylactic acid (PLA) as described below. The particle size of the torrefied sorghum was ˜500 micrometers.

FIG. 4 shows flexural strength of torrefied sorghum biocomposites in PLA as described below. The particle size of the torrefied sorghum was ˜500 micrometers.

FIG. 5 shows flexural toughness of torrefied sorghum biocomposites in PLA as described below. The particle size of the torrefied sorghum was ˜500 micrometers.

FIG. 6 shows moisture transmission rate of polypropylene and torrefied walnut shells biocomposite films as described below.

### DETAILED DESCRIPTION OF THE INVENTION

Disclosed are composites containing (a) plastics (e.g., virgin, recycled or reclaimed plastics) and (b) torrefied biomass, wherein the plastics and the torrefied biomass are compounded to create a composite.

Unless defined otherwise, all technical and scientific terms used herein generally have the same meaning as commonly understood by one of ordinary skill in the art to which this disclosure belongs. The definitions below are intended to be used as a guide for one of ordinary skill in the art and are not intended to limit the scope of the invention. Mention of tradenames or commercial products is solely for the purpose of providing specific information or examples and does not imply recommendation or endorsement of such products.

“Virgin plastic” is the resin produced directly from the petrochemical feed-stock, such as natural gas or crude oil, which has never been used or processed before. “Recycled” or “reclaimed” in this context means the process of recovering waste plastic and reprocessing it into a wide array of end products. Typically, the plastic (e.g., virgin, recycled or reclaimed plastics) is sorted into different polymers and then melt mixed in an extruder. The extruded strands are then cooled, pelletized, and subsequently processed via injection molding or other known polymer processes to form the desired product. The term “recycled” or “reclaimed” plastic may be a homogenous or heterogeneous mixture of various different types of plastics. The types of plastics that can be “recycled” or “reclaimed” can include but are not limited to polypropylene (PP), low-density polyethylene (about 0.910 to about 0.940 g/cm³) (LDPE), high-density polyethylene (about 0.930 to about 0.970 g/cm³) (HDPE), polystyrene (PS), and/or combinations therein.

“Biomass” in this context means plant-based material generally containing hemicellulose, cellulose, and lignin. It can also mean organic residues obtained from harvesting and processing of agricultural crops. Examples of biomass can include but are not limited to native sources such as rice straw, wheat straw, cotton, corn stover, sorghum, wood such as yellow pine, almond, agricultural residue, and forest litter.

“Additive” in this context means a fiber or mineral which is melt-blended into a polymer to modify its properties.

“Torrefaction” in this context means pyrolysis of biomass under an inert atmosphere (e.g., nitrogen, argon) at temperatures between about 200° and about 300° C. (e.g., 200° to 300° C., preferably about 240° to about 280° C. (240°-280° C.), more preferably about 260° (260° C.)) for a certain residence time (e.g., about 1-2 seconds to about 4 or more hours, more preferably between about 30 to about 120 minutes (30-120 minutes)). The temperature and residence time chosen for the process will determine the degree of torrefaction of the fibers. During the torrefaction process, hemicellulose, amorphous cellulose, and volatile organic acids and oils within the fibers are converted to a densified brown to black uniform solid biomass, becoming a more hydrophobic product which can degrade between about 300° C. and about 375° C. (e.g., 300°-375° C.).

“Heat deflection temperature” or “heat distortion temperature” means a temperature that is determined by heating the polymer material and noting the point in which significant softening has occurred, allowing the sample to be readily pliable. Improved heat resistance and improved thermal stability correspond to higher heat deflection temperatures.

“Improved barrier properties” means having a contact angle value higher than unmodified plastics (e.g., virgin, recycled or reclaimed plastics). Contact angle is one of the common ways to measure the wettability of a surface or material. Wetting refers to how a liquid deposited on a solid substrate spreads out. The wetting is determined by measuring the contact angle which the liquid forms in contact with solids. The wetting tendency is larger the smaller the contact angle or the surface tension is. A wetting liquid is a liquid that forms a contact angle with the solid which is smaller than 90°. A non-wetting liquid creates a contact angle between 90° and 180° with the solid.

“Improved barrier properties” also means having the ability to decrease the oxygen transmission rate (OTR). OTR is an important factor in measuring the effectiveness of a barrier material, particularly film, laminates, or plastic-coated papers.

This disclosure accordingly provides a polymer composite containing plastics (e.g., virgin, recycled or reclaimed plastics) blended with biomass fillers. The plastics (e.g., virgin, recycled or reclaimed plastics) in this disclosure can be polypropylene (PP), low-density polyethylene (LDPE), high-density polyethylene (HDPE), polystyrene (PS), and/or combinations of the aforementioned plastics. The biomass additives in this disclosure are torrefied biomass from different agricultural feedstocks, such as almond, walnut, pistachio shells, almond hulls, rice hulls, and sorghum. The composite is prepared by melt-blending the recycled or reclaimed plastics along with torrefied biomass via extrusion. The resultant composite has a higher heat deflection temperature and better mechanical and barrier properties than the unfilled polymer (i.e., the polymer without torrefied biomass).

An embodiment of the disclosure is a composite containing “virgin” or “recycled” or “reclaimed” plastic. The types of plastics that are “virgin” or can be “recycled” or “reclaimed” can include but are not limited to polypropylene (PP), low-density polyethylene (LDPE), high-density polyethylene (HDPE), polystyrene (PS), and/or combinations of the aforementioned plastics.

Another embodiment of the disclosure is a composite wherein the “virgin” or “recycled” or “reclaimed” plastic polymer is about 50 to about 90 percent (e.g., 50-90%) of the total weight of the composite, preferably in the range of about 60 to about 80 percent (e.g., 60-80%).

Another embodiment of the disclosure is a composite wherein the “virgin” or “recycled” or “reclaimed” polymer has a number average molecular weight between about 10,000 and about 1,000,000 Daltons (e.g., 10,000-1,000,000 Daltons), preferably in the range of about 30,000 to about 100,000 Daltons (e.g., 30,000 to 100,000 Daltons).

Another embodiment of the disclosure is a composite wherein the “virgin” or “recycled” or “reclaimed” polymer has a melt flow index (MFI) between about 2 and about 10 g/10 min at 230° C. (e.g., 2-10 g/10 min at 230° C.), preferably in the range of about 4 and about 8 g/10 min at 230° C. (e.g., 4-8 g/10 min at 230° C.).

Another embodiment of the disclosure is a composite containing (1) recycled plastics and (2) torrefied biomass.

An embodiment of the disclosure is a composite wherein the torrefied biomass is produced through torrefaction. Torrefaction involves the pyrolysis of biomass in temperature from about 200° to about 300° C. (e.g., 200-300° C.) under non-oxygenated conditions (e.g., inert nitrogen, carbon dioxide, or argon environment). The temperature and residence time chosen for the process will determine the degree of torrefaction of the fibers. Biomass may come from but is not limited to fibers from native sources such as rice straw, wheat straw, cotton, corn stover, sorghum, wood such as yellow pine, almond, other agricultural residue, and forest litter.

An embodiment of the disclosure is a composite wherein the torrefied biomass has been torrefied between about 200° to about 300° C. (e.g., 200°-300° C.) under non-oxygenated conditions, preferably between about 260° to about 290° C. (e.g., 260°-290° C.).

An embodiment of the disclosure is a composite wherein the torrefied biomass has been torrefied between about 30 to about 180 minutes (e.g., 30-180 minutes) under non-oxygenated conditions, preferably between about 30 to about 60 minutes (e.g., 30-60 minutes).

An embodiment of the disclosure is a composite wherein the biomass has been torrefied to yield a torrefied biomass which degrades between about 300° and about 400° C. (e.g., 300°-400° C.), preferably from about 300° to about 375° C. (e.g., 300°-375° C.).

An embodiment of the disclosure is a composite wherein the torrefied biomass has a particle size between about 1 to about 1000 microns (e.g., 1-1000 microns), preferably from about 50 to about 200 microns (e.g., 50-200 microns). Another embodiment of the disclosure is a composite wherein the torrefied biomass has a particle size between about 1 to about 1000 nm (e.g., 1-1000 nm), preferably from about 250 to about 650 nm (250-650 nm), more preferably about 350 to about 550 nm (350-550 nm), and more preferably about 400 to about 500 nm (400-500 nm).

An embodiment of the disclosure is a composite wherein the torrefied biomass is from about 5 to about 40 percent (e.g., 5-40 percent) of the total weight of the composite, preferably from about 15 to about 30 percent (e.g., 15-30 percent).

In some embodiments, various articles of manufacture may be formed with composites of the disclosure. For example, processes such as extruding, injection molding, sheet forming, blow molding, and thermoforming may be used to create articles including cutlery, containers for packaging, hot server items, hard plastic casings, 3-D printed items, and other items. It should be appreciated that a person of ordinary skill in the art may select any suitable known process to create any article of manufacture from the composite of this disclosure.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition the invention encompasses any possible combination that also specifically excludes any one or some of the various embodiments and characteristics described herein and/or incorporated herein. The amounts, percentages and ranges disclosed herein are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

The polymer composites described herein can be made using techniques well known in the art. Prior to compounding (i.e., the process of melt-blending plastics together optionally with other additives, typically using an extruder), each component of the final biopolymers composition in the following examples was dried at 90° C. overnight in a convection oven. It should be appreciated that a broad range of drying temperatures (e.g., about 80° C. to about 120° C.)). (80°-120° may be used to dry the components as determined by a person of ordinary skill in the art. The final formulations are generally stored with desiccant to avoid damage through moisture absorption. Though any suitable device may be used, the polymer blends were prepared with a twin-screw extruder (Leistritz, Somerville, N.J., Micro 18 co-rotating twin-screw extruder) which had six heating zones. The temperatures used for blending ranged from about 170° C. to about 190° C. (e.g., 170° to 190° C.). The resulting blends were then compression molded between two heated plates at 185° C. into discs with dimensions 7″ diameter×0.020″ thickness. Then 0.5″ width×2.5″ length×1.5″ thickness rectangular samples were cut from the compression molded discs for mechanical testing.

The heat deflection temperature curves of the samples were obtained from a thermomechanical analyzer (TA Instruments, New Castle, Del., thermomechanical analyzer model TMA 2940). Each sample was cut into a rectangular piece with a length of 19 mm, a width of 4.96 mm, and a thickness of 1.56 mm, the required dimensions as specified by the manufacturer of the thermomechanical analyzer. The sample was held at 30° C. for one minute and then the temperature was ramped at 10° C./min up to 200° C. The purpose of holding the sample at 30° C. was to ensure that the internal temperature of the samples prior to the start of the test was the same. Ramping the temperature allowed determination of the sample's behavior from 30° C. to 200° C. In general, a plastic will begin to “soften” as its internal temperature is increased. The instrument measured how much the sample “softens,” or “deflects,” which yielded a heat deflection temperature curve for the sample. From the curve, the temperature at which the sample “softened” or “deflected” was determined.

The contact angle values were obtained using a video contact angle system (DSA30, Kruss, Hamburg, Germany). The contact liquid used was distilled water. The volume of the droplet was 10 pL, and the contact angle given is the average value of 3 measurements.

Ecoplast, purchased from FDS MFG (Pomona, Calif.), contained 58% recycled PP and 42% recycled HDPE.

Oxygen permeability (OP) of Ecoplast and torrefied biomass-Ecoplast composite films were measured at 25° C. and 50±1% RH using an Ox-Tran 2/20 modular system (Modern Controls Inc., Minneapolis, Minn.). The films were prepared by cutting circular pieces using a round watch glass and razor blade. Film thickness was measured before testing oxygen permeability with a micrometer at 5 random positions. Each film was placed on a stainless steel mask with an open testing area of 5 cm². Masked films were placed into the test cell and exposed to 98% N₂+2% H₂ flow on one side and pure oxygen flow on the other. Oxygen permeability was calculated by dividing O₂ transmission rate by the difference in O₂ partial pressure between both sides of the film (1 atm) and multiplying by the average film thickness. Four replicates of each film were evaluated.

### Example 1: Preparation of Torrefied Almond Shells

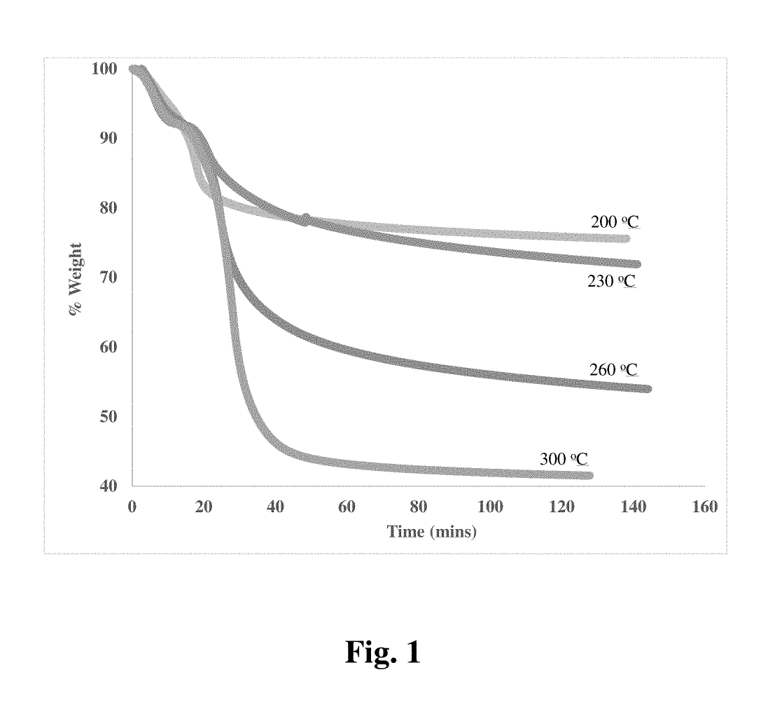

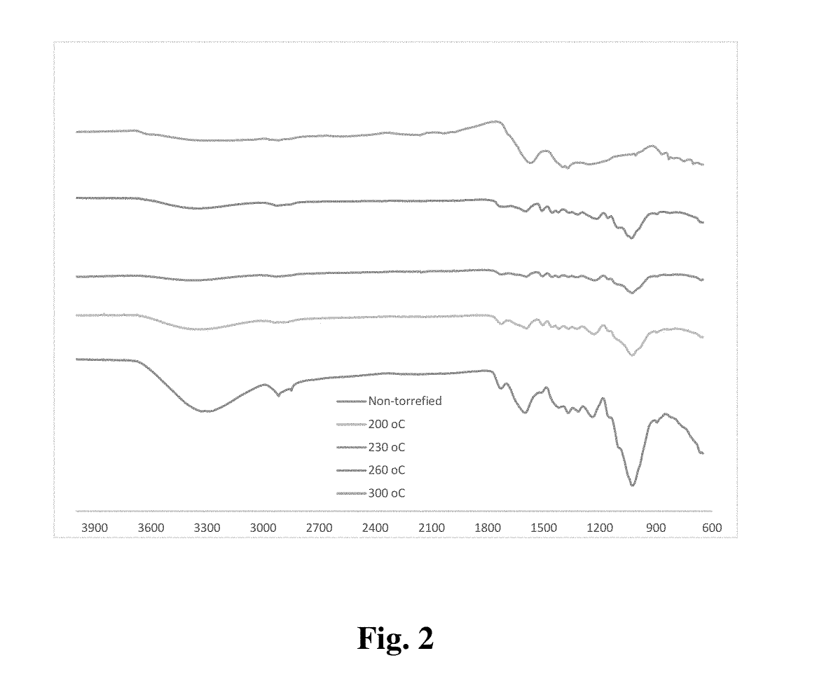

Prior to torrefaction, the shells were ground using an industrial Wiley mill. Thermogravimetric analysis under nitrogen was performed before the torrefaction procedure to optimize the torrefaction temperatures. Two criteria were established: (1) increased hydrophobicity of the biomass and (2) relatively high yields after torrefaction. The increased hydrophobicity would result in improved fiber adhesion to the polymer matrix, providing improvements in mechanical and thermomechanical properties of the biocomposites. Secondly, yields greater than 50 by weight % of the starting biomass were sought in order for the process to be economically viable. The torrefaction temperatures of ground almond shells were at different temperatures, such as 200°, 230°, 260°, and 300° C., are shown in FIG. 1. The yield at 260° C. was roughly 60 by weight % of the starting material. It was also observed (FIG. 2) that a significant amount of the —OH groups (stretch between 3000-3600) decreased, showing increased hydrophobicity. It was determined that a torrefaction temperature of ˜260° C. would be the optimized condition for the torrefaction process.

As seen from the data in FIG. 1, increasing the torrefaction temperature of the unmodified almond shells decreased the overall percent yield of the torrefied biomass. A dramatic increase in mass loss was observed between 230° and 260° C. At 300° C., ˜40% of the original mass remained. This is in line with the mechanism of torrefaction. Breakdown of the cellulose and hemicellulose occurs, producing gases and volatile organics.

As seen from the data in FIG. 2, the characteristic absorbance of —OH functional group in the range of 3000-3600 cm−¹ decreased as the torrefaction temperature increased. This resulted in an increase in hydrophobicity of the material. This change in absorbance was more pronounced in the temperature range of 230° to 260° C.

The shells were torrefied using a high temperature convection furnace. The size of the chamber limited the amount of biomass that could be torrefied at one time to approximately 1 kg. To prevent combustion of the biomass during the heating process, an inert atmosphere was maintained using nitrogen gas at a flow rate of approximately 150 mL/min. The biomass was heated to 260° C. and held at temperature for 1 h. The biomass was then allowed to cool to room temperature in the inert atmosphere. Thermogravimetric analysis (TGA) of the untorrefied and torrefied biomasses was conducted using a Perken Elmer Pyris 1 TGA. A temperature ramp of 10° C. per minute from room temperature to 500° C. was used to analyze the biomass. The torrefied almond shells were ground further and then sieved to produce a particle size in the range of about 100 to about 200 microns.

All materials were dried overnight at 80° C. in a convection oven prior to extrusion. The torrefied biomass and recycled plastic were melt compounded using a twin-screw extruder (Leistritz, Somerville, N.J., Micro 18 co-rotating twin-screw extruder) which had six heating zones. The temperature of the six heating zones within the extruder were as follows: 165° C., 170° C., 175° C., 180° C., 185° C., and 185° C. from feed to die. Four varying weight percentages were used for each biomass: 5, 10, 15, and 20 wt %. The resulting blends were then compression molded between two heated plates at 185° C. into discs with dimensions 7″ diameter×0.020″ thickness. Then 0.5″ width×2.5″ length×1.5″ thickness rectangular samples were cut from the compression molded discs for mechanical testing. The compression molded disc was also cut to provide a sample for heat deflection temperature testing using a thermomechanical analyzer. For comparison, data for unfilled recycled plastic was also included. For another comparison, a summary of the flexural properties and thermomechanical analysis of Ecoplast melt blended with industrial fillers (e.g., talc, calcium carbonate, and non-torrefied biomass) is provided in Table 1. Table 2 summarizes the modulus, strength, and toughness data for unfilled recycled plastic and resulting blends with torrefied biomass for this study. Tables 3 and 4 summarize the contact angle and oxygen transmission rates.

Table 1 summarizes the effect of melt-blending commercially available fillers on the flexural and heat deflection properties of recycled polypropylene. For this example, mineral and unmodified (non-torrefied) biomass fillers were used. The particle size of the fillers varied from 400 nm to 2000 microns. As seen from the data, the addition of these fillers decreased the flexural modulus and yield strength of the composite with the exception of talc. Talc has been known to act as a reinforcing agent, which may, without being bound by theory, explain the observed increase in flexural modulus and yield strength. The talc composite also produced a higher heat deflection temperature.

Table 2 summarizes the effect of melt-blending torrefied almond shells on the flexural and heat deflection properties of recycled polypropylene. The torrefied almond shells were torrefied at 260° C. for 2 hours. The average particle size of the torrefied almond shells was about 150 microns. As seen from the data, the addition of the torrefied almond shells surprisingly increased the flexural modulus and heat deflection temperature of the composites. At 20% loading, the flexural modulus of the torrefied almond shell composite was surprisingly comparable to the composite with talc. All the torrefied almond shell composites surprisingly had higher heat deflection values than the composites with industrial fillers. Torrefaction surprisingly increased the hydrophobicity of the ground almond shells, changing the surface reactivity and allowing for enhanced interaction between the filler and plastic matrix without the addition of costly compatibilizers. Torrefying the almond shells also surprisingly provided increased thermal stability, allowing the shells to be melt blended into plastic with very little observable thermal degradation.

Table 3 summarizes the effect of melt blending torrefied almond shells on the surface hydrophobicity property of recycled polypropylene. As seen from the data, the addition of torrefied almond shells surprisingly increased the contact angle of the composite, which indicated an increase in water repellency. As previously mentioned, torrefaction surprisingly increased the hydrophobicity of the ground almond shells, changing the surface reactivity and allowing for enhanced interaction between the filler and plastic matrix.

Table 4 summarizes oxygen permeability of the torrefied almond shell composites. The addition of the torrefied almond shells surprisingly decreased the oxygen permeability of the recycled polypropylene. Typically, the presence of “debonding” between filler and plastic matrix typically leads to increases in oxygen permeability in some composites. Torrefaction of the almond shell filler increased its hydrophobicity, thus enhancing interaction between the filler and plastic matrix.

### Example 2: Preparation of Torrefied Walnut Shells

Prior to torrefaction, the shells were ground using an industrial Wiley mill. The shells were torrefied using a high temperature convection furnace. The size of the chamber limited the amount of biomass that could be torrefied at one time to approximately 1 kg. To prevent combustion of the biomass during the heating process, an inert atmosphere was maintained using nitrogen gas at a flow rate of approximately 150 mL/min. The biomass was heated to 260° C. and held at temperature for 1 h. The biomass was then allowed to cool to room temperature in the inert atmosphere. Thermogravimetric analysis (TGA) of the untorrefied and torrefied biomasses was conducted using a Perken Elmer Pyris 1 TGA. A temperature ramp of 10° C. per minute from room temperature to 500° C. was used to analyze the biomass. The torrefied walnut shells were ground further and then sieved to produce a particle size in the range of 100-200 microns.

Table 5 summarizes the effect of melt blending torrefied walnut shells on the flexural and heat deflection properties of recycled polypropylene. The torrefied walnut shells were torrefied at 260° C. for 2 hours. The particle size of the torrefied walnut shells were about 150 microns. At 10% loading, the flexural modulus of the torrefied almond shell composite was surprisingly comparable to the composite with talc. All the torrefied almond shell composites surprisingly had higher heat deflection values than the composites with industrial fillers.

### Example 3: Preparation of Torrefied Sorghum

Table 6 summarizes the tensile properties of torrefied sorghum biocomposites. Torrefied sorghum was blended into recycled polypropylene at different loadings of 5-30%. The addition of torrefied sorghum surprisingly did not have an adverse effect on the tensile modulus and tensile strength of the recycled polypropylene. Moreover, at 30 by weight % loading, the composite surprisingly exhibited an increase in modulus, possibly due to the reinforcing effect of the filler. The tensile toughness decreased with increased loading of the filler.

Heat resistance of the neat recycled material were compared to the torrefied sorghum biocomposites (see Table 7). Very little change was observed for the HDT values of the biocomposites. However, at 30% loading, surprisingly the HDT value was ˜152° C., which was slightly higher than the neat recycled material. This may be attributed to the increased reinforcement, which was also observed in the tensile modulus (see Table 7).

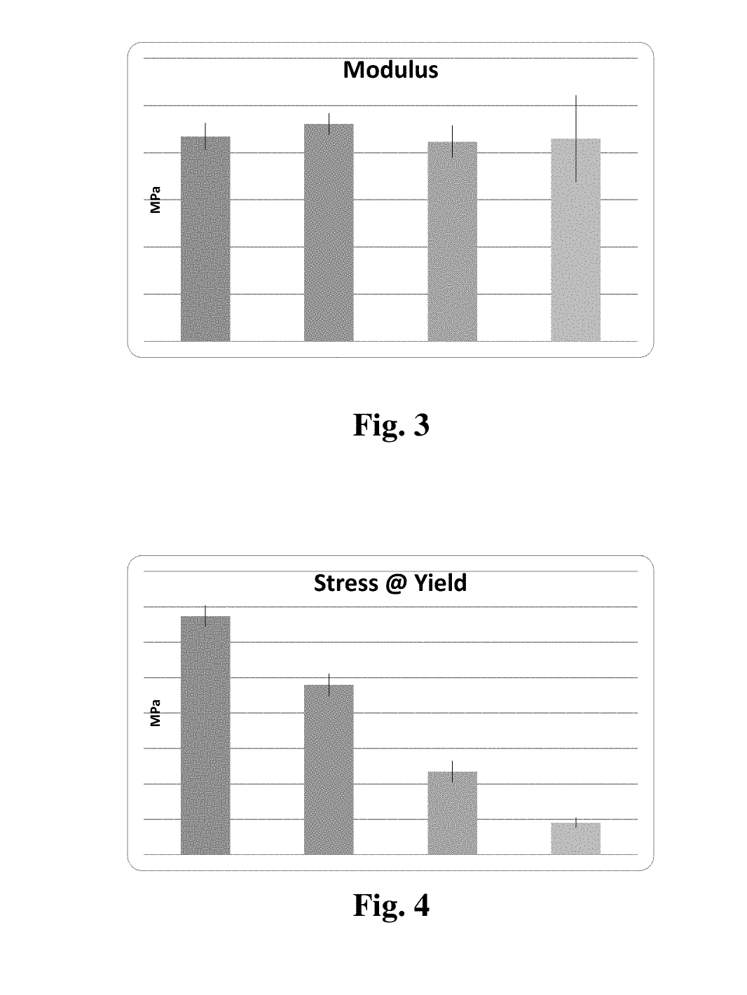

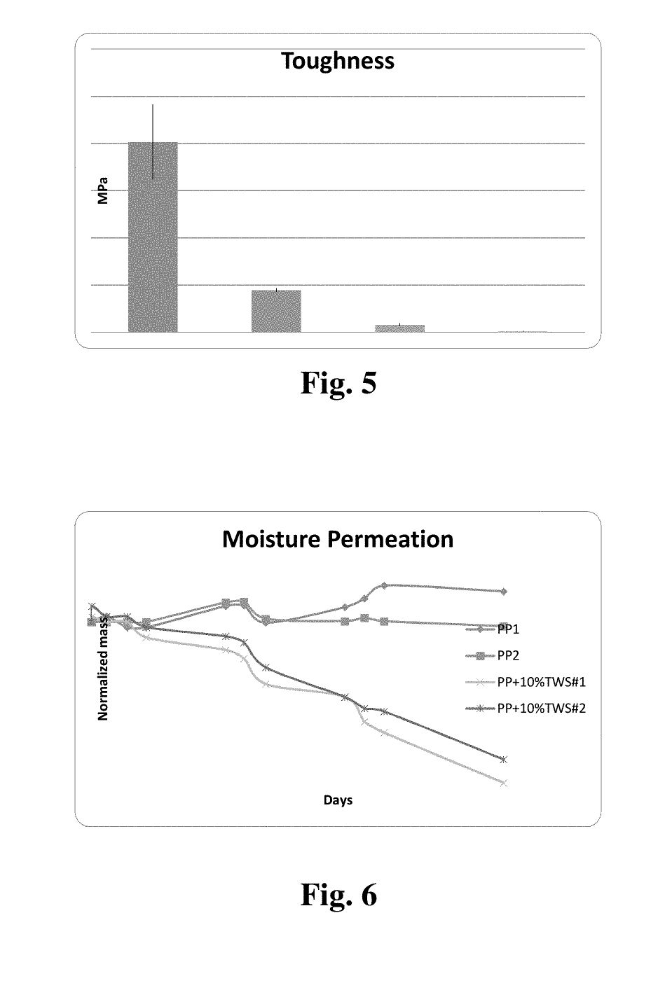

Mechanical properties of torrefied sorghum biocomposites using polylactic acid (PLA): Polylactic acid (PLA) is fast becoming a viable alternative to petroleum-based plastics in the market since. PLA is biodegradable, is generated from renewable resources, and like most thermoplastics, can be easily formed into different products using standard industrial processes such as injection molding or thermoforming. Another end-use for the torrefied biomass was a filler for PLA to improve mechanical properties of the composite. FIG. 3 and FIG. 4 show the flexural properties of torrefied sorghum biocomposites in PLA. Increased loadings of the filler decreased the flexural strength, as well as the toughness, of the bicomposites. No effect was observed with the flexural modulus.

### Example 4: FIG. 6 Exhibits the Water Permeability of the Torrefied Walnut Shell Composites

The data show that the addition of torrefied walnut shells surprisingly increased the moisture permeability of the polypropylene. Typically, the presence of “debonding” between filler and plastic matrix leads to an increase in permeability in composites.

### Example 5

Incorporated by reference Is “Evaluation of Torrefied Sorghum As A Filler In Linear Low Density Polyethylene And Polypropylene” which is a private report prepared for Agri-Tech Producers, LLC, by the University of Akron; a copy is being provided with this application. The Executive Summary is as follows:

“We have evaluated composites of polypropylene (PP), as well as linear low density polyethylene (LLDPE) thermoplastics filled with Torrefied Sorghum (TS) (up to 50 wt. %) to assess its efficacy in improving mechanical, thermal and water uptake properties. PP and LLDPE was mixed with as-received and ball-milled torrefied sorghum (GTS), by adding in different percentages. Mixing was done using a mini compounder at 190° C.-200° C. and 165° C. using PP and LLDPE, respectively at 20 rpm mixing rate for 20 minutes. After compounding, three or more dog-bone shape samples were formed from the same batch, and for each condition, via DSM Research Micro-Injection molding machine at temperatures 190° C. and 160° C. for PP and LLDPE, respectively. The mechanical properties of the blends obtained in this manner were investigated by tensile testing and the fracture surfaces of the samples were observed after the tensile test by using scanning electron microscopy (SEM). Thermal behaviors of blends were characterized by using Differential Scanning calorimetry (DSC) analyses. Thermal stability of composites were determined by using thermo gravimetric analysis (TGA) under elevated temperature. Heat Distortion Temperatures (HDT) were obtained using Dynamic Mechanical Analyses (DMA). Environmental stability of the composites was assessed using liquid absorption and swelling experiments over a 7-day period by immersion in pure water with pH 7, 0.01 M Dilute HCl solution with pH 2 and 0.01 M dilute NaOH solution with pH 12.

Elastic modulus of PP increased with an increasing Torrefied Sorghum (TS) amount for both as received and ground PP/TS specimens. No significant difference has been observed between as received and ground TS-filler specimens. On the other hand, maximum stress and strain at maximum stress decreased with increasing amount of TS filler.

Elastic modulus and maximum stress values for LLDPE increased with increasing amount of TS filler for both as received and ground LLDPE/TS specimens. Strain at maximum stress decreased with increasing amount of TS filler.

When the trends of the elastic moduli for PP/TS and LLDPE/TS composites were compared, the effect of torrefied sorghum amount was found to be similar on both composites, resulting in increasing behavior for the elastic moduli in similar proportions. In the case of strain values at maximum stress, TS addition affected LLDPE more than PP with higher amounts of strain reduction. The maximum stress values presented opposite behaviors with those for LLDPE increasing while those for PP decreasing. At the highest TS amount added (50% wt.) the maximum stress and the corresponding strain values for both LLDPE/TS and PP/TS composites became very close.

There is no appreciable change in melting temperatures for the PP/TS and LLDPE/TS composites with TS filler addition up to 50 wt. %.

Heat Distortion Temperature (HDT) of PP/TS and humidified PP/TS composites increased with an increasing amount of TS. When compared with neat PP, up to 31.72° C. and 30.92° C. increases were obtained for heat distortion temperatures of PP/TS and humidified PP/TS composites, respectively, with TS filler addition of up to 50 wt. %. The efficacy of larger (as received) TS particles is better in increasing the heat distortion temperature for the composite in comparison to the use of smaller (ground) TS particles.

HDT of LLDPE/TS increased with an increasing amount of TS resulting in 25.57° C. enhancement.

The carbon convertion of as-received torrefied sorghum was determined to be approximately 78.42% by using Thermogravimetric Analysis (TGA).

Thermal stability of PP/TS, PP/GTS, LLDPE/TS and LLDPE/GTS composites were found to be higher than the neat PP and LLDPE materials, and their stability increased with increasing amount of TS/GTS fillers, as determined using TGA by the residual weight method. The residual weights of the TS-filled composites were slightly less than those for their GTS-filled counterparts.

Among the TS filled polymers tested, for the PP/TS composite, the maximum water uptake was ˜6% and the maximum thickness swelling was ˜4.5%. For the LLDPE/TS composite, the maximum water uptake was ˜8% and the maximum thickness swelling was ˜3.5%.”

For the foregoing reasons, it is clear that the compositions described herein provide a composite containing a torrefied biomass and virgin or recycled or reclaimed plastic. The current material may be modified in multiple ways and applied in various technological applications. Although the materials of construction are generally described, they may include a variety of compositions consistent with the function described herein. Such variations are not to be regarded as a departure from the spirit and scope of this disclosure, and all such modifications as would be obvious to one skilled in the art are intended to be included within the scope of the following claims.

All of the references cited herein, including U.S. patents and U.S. patent application Publications, are incorporated by reference in their entirety. Also incorporated by reference in their entirety are the following references: U.S. Pat. No. 10,086,417; Cooperative Research and Development Agreement No. 58-2030-6-033 between the U.S. Agricultural Research Service and Agri-Tech Producers, LLC; Arrakhiz, F. Z., et al., Evaluation of mechanical and thermal properties of pine cone fibers reinforced compatibilized polypropylene, Mater. Des., 40: 528-535 (2012); Berthet, M.-A., et al., Vegetal fiber-based biocomposites: which stakes for food packaging applications?, J. Appl. Polym. Sci., 133 (2016); Chen, P., et al., Influence of fiber wettability on the interfacial adhesion of continuous fiber-reinforced PPESK composite, J. Appl. Polym. Sci., 102: 2544-2551 (2006); Chiou, B.-S., et al., Torrefied biomass-polypropylene composites, J. Appl. Polym. Sci., 132 (2015); Chiou, B.-S., et al., Torrefaction of almond shells: effects of torrefaction conditions on properties of solid and condensate products, Ind. Crops Prod., 86 (August 2016); Dikobe, D. G., and A. S. Luyt, A. S., Thermal and mechanical properties of PP/HDPE/wood powder and MAPP/HDPE/wood powder polymer blend composites, Thermochim. Acta, 654: 40-50 (2017); Essabir, H., et al., Bio-composites based on polypropylene reinforced with almond shells particles: mechanical and thermal properties, Mater. Des. 51, 225-230 (2013); Faruk, O., Biocomposites reinforced with natural fibers: 2000-2010, Prog. Polym. Sci., 37: 1552-1596 (2012); Fu, S.-Y., et al., Effects of particle size, particle/matrix interface adhesion and particle loading on mechanical properties of particulate-polymer composite, Compos. Part B: Eng., 39: 933-961 (2008); Girones, J., et al., Crystallization of polypropylene in the presence of biomass-based fillers of different compositions, Polymer, 127: 220-231 (2017); Iyer, K. A., et al., Green polypropylene/waste paper composites with superior modulus and crystallization behavior: optimizing specific energy in solid-state shear pulverization for filler size reduction and dispersion, Compos. Part A: Appl. Sci. Manuf., 83: 47-55 (2016); Laadila, M. A., et al., Green synthesis of novel biocomposites from treated cellulosic fibers and recycled bio-plastic polylactic acid, J. Clean Prod. 164: 575-586 (2017); Lee, B.-H., et al., Bio-composites of kenaf fibers in polylactide: role of improved interfacial adhesion in the carding process, Compos. Sci. Technol., 69: 2573-2579 (2009); Malkapuram, R., et al., Recent development in natural fiber reinforced polypropylene composites, J. Reinf. Plast. Compos., 28: 1169-1189 (2009); McCaffrey, Z., Recycled polypropylene-polyethylene torrefied almond shell biocomposites, Industrial Crops and Products, 125: 425-432 (2018); Peng, J. H., et al., A study of particle size effect on biomass torrefaction and densification, Energy Fuels, 26: 3826-3839 (2012); Pickering, K. L., et al., A review of recent developments in natural fibre composites and their mechanical performance, Compos. Part Appl. Sci. Manuf., 83: 98-112 (2016); Pirayesh, H., and A. Khazaeian, Using almond (Prunus amygdalus L.) shell as a bio-waste resource in wood based composite, Compos. Part B: Eng., 43: 1475-1479 (2012); Pukanszky, B., and G. Vörös, Mechanism of interfacial interactions in particulate filled composites, Compos. Interfaces, 1: 411-427 (1993); Sanjay, M. R., et al., Characterization and properties of natural fiber polymer composites: a comprehensive review, J. Clean. Prod., 172: 566-581 (2018); Soponpongpipat, N., et al., Higher heating value prediction of torrefaction char produced from non-woody biomass, Front. Energy, 9: 461-471 (2015); Zaghloul, M. M. Y., et al., Experimental and modeling analysis of mechanical-electrical behaviors of polypropylene composites filled with graphite and MWCNT fillers, Polym. Test., 63: 467-474 (2017); Zou, Y., et al., Lightweight composites from long wheat straw and polypropylene web, Bioresour. Technol., 101: 2026-2033 (2010).

Thus, in view of the above, there is described (in part) the following:

A composite, said composite comprising (or consisting essentially of or consisting of) (a) plastic (e.g., virgin or recycled or reclaimed) and (b) torrefied biomass, wherein said plastic and said torrefied biomass are compounded to create a composite. The above composite, wherein said plastics (e.g., virgin or recycled or reclaimed) are selected from the group consisting of polypropylene, low-density polyethylene, high-density polyethylene, polystyrene, and mixtures thereof. The above composite, wherein said plastic (e.g., virgin or recycled or reclaimed) has a number average molecular weight between about 10,000 and about 1,000,000 Daltons. The above composite, wherein said plastic (e.g., virgin or recycled or reclaimed) has a number average molecular weight between about 30,000 to about 100,000 Daltons. The above composite, wherein said plastic (e.g., virgin or recycled or reclaimed) has a melt flow index between about 2 and about 10 g/10 min at 230° C. The above composite, wherein said plastic (e.g., virgin or recycled or reclaimed) has a melt flow index between about 4 and about 8 g/10 min at 230° C. The above composite, wherein said plastic (e.g., virgin or recycled or reclaimed) comprises from about 50 to about 90 percent of the total weight of said composite. The above composite, wherein said plastic (e.g., virgin or recycled or reclaimed) comprises from about 60 to about 80 percent of the total weight of said composite. The above composite according to claim 1, wherein said composite is comprised of (a) recycled plastics and (b) torrefied biomass. The above composite, wherein said composite is comprised of (a) reclaimed plastics and (b) torrefied biomass. The above composite, wherein said torrefied biomass is torrefied agricultural feedstocks. The above composite, wherein said torrefied agricultural feedstocks are selected from the group consisting of almond shells, walnut shells, pistachio shells, almond hulls, rice hulls, rice straw, wheat straw, cotton, corn stover, sorghum, yellow pine, almond, forest litter, sorghum, and mixtures thereof. The above composite, wherein said torrefied biomass has been torrefied between about 200° to about 300° C. under non-oxygenated conditions. The above composite, wherein said torrefied biomass has been torrefied between about 240° to about 280° C. under non-oxygenated conditions. The above composite, wherein said torrefied biomass has been torrefied between about 260° under non-oxygenated conditions. The above composite, wherein said torrefied biomass has been torrefied between about 30 to about 180 minutes under non-oxygenated conditions. The above composite, wherein said torrefied biomass has been torrefied between about 30 to about 120 minutes under non-oxygenated conditions. The above composite, wherein said torrefied biomass has been torrefied between about 30 to about 60 minutes under non-oxygenated conditions. The above composite, wherein said torrefied biomass degrades between about 300° and about 400° C. The above composite, wherein said torrefied biomass degrades between from about 300° to about 375° C. The above composite, wherein said torrefied biomass has a particle size between about 1 to about 1000 microns. The above composite, wherein said torrefied biomass has a particle size between about 50 to about 200 microns. The above composite, wherein said torrefied biomass comprises from about 5 to about 40 percent of the total weight of said composite. The above composite, wherein said torrefied biomass comprises from about 10 to about 30 percent of the total weight of said composite. The above composite, wherein said composite is prepared by a process comprising melt-blending said recycled or reclaimed plastic with said torrefied biomass via extrusion. The above composite, wherein said composite has a higher heat deflection temperature than a composite comprising recycled or reclaimed plastic but no torrefied biomass. The above composite, wherein said composite has a higher yield strength than a composite comprising recycled or reclaimed plastic but no torrefied biomass. The above composite, wherein said composite has a higher flexural modulus than a composite comprising recycled or reclaimed plastic but no torrefied biomass. The above composite, wherein said composite does not contain a compatiblilizer. The above composite, wherein said composite does not contain any of the following: additives that are typically melt-blended via extrusion into recycled plastics to improve or broaden the range of properties of the reclaimed materials; glass fibers, calcium carbonate, and elastomers (e.g., natural rubber), talc powder, carbon black, talc, titanium dioxide, compatibilizers (e.g., petroleum-based industrial compatibilizers such as polypropylene-graft-maleic anhydride). The above composite, wherein said plastic is not virgin plastic. The above composite, wherein said plastic is not recycled plastic. The above composite, wherein said plastic is not reclaimed plastic.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The invention illustratively disclosed herein suitably may be practiced in the absence of any element (e.g., method (or process) steps or composition components) which is not specifically disclosed herein. Thus the specification includes disclosure by silence (“Negative Limitations In Patent Claims,” AIPLA Quarterly Journal, Tom Brody, 41(1): 46-47 (2013): “ . . . Written support for a negative limitation may also be argued through the absence of the excluded element in the specification, known as disclosure by silence. . . . Silence in the specification may be used to establish written description support for a negative limitation. As an example, in Ex parte Lin [No. 2009-0486, at 2, 6 (B.P.A.I. May 7, 2009)] the negative limitation was added by amendment. . . . In other words, the inventor argued an example that passively complied with the requirements of the negative limitation . . . was sufficient to provide support. . . . This case shows that written description support for a negative limitation can be found by one or more disclosures of an embodiment that obeys what is required by the negative limitation. . . . ”

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Summary of flexural and heat deflection data (HDT) for composites
comprised of Ecoplast (recycled polypropylene) (a) and industrial
fillers at 20 by weight % loading: (a) Ecoplast crushed, (b) unmodified
walnut shells, (c) talc, and (d) calcium carbonate.

| | Modulus | Yld. Strength | HDT |
|---|---|---|---|
| Samples | (MPa) | (MPa) | (° C.) |
| (a) Ecoplast | 1011 ± 88 | 31 ± 2 | 125 |
| (b) Walnut shells | 636 ± 109 | 19 ± 3 | 120 |
| (c) Talc | 1488 ± 108 | 64 ± 7 | 131 |
| (d) Calcium carbonate | 630 ± 79 | 23 ± 2 | 127 |

TABLE 2
Summary of flexural and heat deflection data (HDT) for composites
comprised of Ecoplast (recycled polypropylene) (a) and torrefied
almond shells at 5% (b), 10% (c), and 20% (d) by weight loading.

| | Modulus | Strength | HDT |
|---|---|---|---|
| Samples | (MPa)* | (MPa)* | (° C.) |
| (a) Ecoplast PP | 1011 ± 88 | 31 ± 2 | 144 |
| (b) 5% Torrefied Almond shells | 1120 ± 82 | 31 ± 0.60 | 146 |
| (c) 10% Torrefied Almond shells | 1209 ± 70 | 33 ± 2 | 148 |
| (d) 20% Torrefied Almond shells | 1400 ± 54 | 28 ± 0.9 | 159 |

*Avg of 5 samples

TABLE 3
Contact angle measurements of Ecoplast and torrefied
almond shells-Ecoplast biocomposite films.

| Samples | Degrees* |
|---|---|
| Ecoplast | 80.9 |
| 5% Torrefied almond shells | 90.9 |
| 10% Torrefied almond shells | 92.5 |
| 20% Torrefied almond shells | 95.3 |

*Avg of 3 samples

TABLE 4
Oxygen transmission rate (OTR) of Ecoplast and torrefied
almond shells-Ecoplast biocomposite films.

| Samples | OTR (cm3 · mil/m2 · day · atm) |
|---|---|
| Ecoplast | 2050.5 |
| 5% Torrefied almond shells | 1955.9 |
| 10% Torrefied almond shells | 1716.3 |
| 20% Torrefied almond shells | 1446.5 |

TABLE 5
Summary of flexural and heat deflection data (HDT) for composites
comprised of Ecoplast (recycled polypropylene) (a) and torrefied
walnut shells at 5% (b), 10% (c), and 20% (d) by weight loading.

| | Modulus | Strength | HDT |
|---|---|---|---|
| Samples | (MPa)* | (MPa)* | (° C.) |
| (a) Ecoplast PP | 1011 ± 88 | 31 ± 2 | 144 |
| (b) 5% Torrefied walnut shells | 925 ± 58 | 34 ± 2 | 147 |
| (c) 10% Torrefied walnut shells | 1241 ± 75 | 35 ± 2 | 151 |
| (d) 20% Torrefied walnut shells | 821 ± 47 | 24 ± 0.9 | 153 |

*Avg of 5 sample

TABLE 6
Tensile data for torrefied sorghum composites (500 micrometers)

| | | | BRK % | MAX | | ASTM |
|---|---|---|---|---|---|---|
| Date Tested | Sample Name | Mod. | STN | STR | Toughness | method |
| Aug. 27, 2018 | Recycled PP | 892.749 | 98.833 | 17.799 | 14.387 | D882 |
| | | 775.004 | 85.722 | 17.364 | 12.183 | |
| | | 895.95 | 111.083 | 18.139 | 16.282 | |
| | | 987.892 | 75.514 | 17.628 | 10.576 | |
| | | 899.048 | 111.069 | 17.7 | 15.797 | |
| | Average | 890.129 | 96.444 | 17.726 | 13.845 | |
| | Stdev | 75.72 | 15.71 | 0.28 | 2.42 | |
| Aug. 7, 2018 | 5% TSO/95% | 843.8 | 17.69 | 16.83 | 2.31 | D882 |
| | Recycled PP | 837.3 | 15.53 | 17.26 | 2.124 | |
| | | 912.1 | 34.15 | 17.24 | 4.634 | |
| | | 721.8 | 30.76 | 17.14 | 3.957 | |
| | | 821.8 | 28.1 | 17.42 | 4.046 | |
| | Average | 827.36 | 25.246 | 17.178 | 3.4142 | |
| | Stdev | 68.42 | 8.21 | 0.22 | 1.13 | |
| Aug. 7, 2018 | 10% TSO/90% | 699.6 | 22.86 | 17.8 | 3.403 | D882 |
| | Recycled PP | 945.8 | 11.97 | 18.37 | 1.86 | |
| | | 832.7 | 13.88 | 18.16 | 2.15 | |
| | | 950.7 | 18.01 | 18.43 | 2.723 | |
| | | 993.2 | 18 | 17.8 | 2.724 | |
| | Average | 884.4 | 16.944 | 18.112 | 2.572 | |
| | Stdev | 119.19 | 4.22 | 0.30 | 0.60 | |
| Aug. 7, 2018 | 30% TSO/70% | 1026 | 3.361 | 16.55 | 0.3747 | D882 |
| | Recycled PP | 1178 | 3.194 | 17.15 | 0.3657 | |
| | | 1031 | 2.819 | 16.48 | 0.299 | |
| | | 1034 | 3.139 | 16.72 | 0.3426 | |
| | | 1057 | 3.556 | 16.73 | 0.4117 | |
| | Average | 1065.2 | 3.2138 | 16.726 | 0.35874 | |
| | Stdev | 64.17 | 0.27 | 0.26 | 0.04 | |

The average values are based on 5 specimens.

TABLE 7
HDT of recycled polypropylene and TSO (500 micrometers)

| Sample | Width | Thickness | Length | HDT |
|---|---|---|---|---|
| Name | (mm) | (mm) | (mm) | (C.) |
| Recycled PP | 4.31 | 0.46 | 14.62 | 147.55 |
| | 4.12 | 0.49 | 14.17 | 149.31 |
| 5% TSO/95% | 3.26 | 1.12 | 13.19 | 144.8 |
| Recycled PP | 3.21 | 1.11 | 12.21 | 144.9 |
| 15% TSO/85% | 4.15 | 1.16 | 11.47 | 115.71 |
| Recycled PP | 4.17 | 1.15 | 12.13 | 132.31 |
| 30% TSO/70% | 4.01 | 0.57 | 12.11 | 122.86 |
| Recycled PP | 3.69 | 0.57 | 11.88 | 152.19 |

We claim:

1. A composite, said composite comprising (a) plastic and (b) torrefied biomass, wherein said plastic and said torrefied biomass are compounded to create a composite.

2. The composite according to claim 1, wherein said plastic is selected from the group consisting of polypropylene, low-density polyethylene, high-density polyethylene, polystyrene, and mixtures thereof.

3. The composite according to claim 1, wherein said plastic has a number average molecular weight between about 10,000 and about 1,000,000 Daltons.

4. The composite according to claim 1, wherein said plastic has a number average molecular weight between about 30,000 to about 100,000 Daltons.

5. The composite according claim 1, wherein said plastic has a melt flow index between about 2 and about 10 g/10 min at 230° C.

6. The composite according claim 1, wherein said plastic has a melt flow index between about 4 and about 8 g/10 min at 230° C.

7. The composite according to claim 1, wherein said plastic comprises from about 50 to about 90 percent of the total weight of said composite.

8. The composite according to claim 1, wherein said plastic comprises from about 60 to about 80 percent of the total weight of said composite.

9. The composite according to claim 1, wherein said composite is comprised of (a) recycled plastic and (b) torrefied biomass.

10. The composite according to claim 1, wherein said composite is comprised of (a) reclaimed plastic and (b) torrefied biomass.

11. The composite according to claim 1, wherein said torrefied biomass is torrefied agricultural feedstocks.

12. The composite according to claim 1, wherein said torrefied agricultural feedstocks are selected from the group consisting of almond shells, walnut shells, pistachio shells, almond hulls, rice hulls, rice straw, wheat straw, cotton, corn stover, sorghum, yellow pine, almond, forest litter, sorghum, and mixtures thereof.

13. The composite according to claim 1, wherein said torrefied biomass has been torrefied between about 200° to about 300° C. under non-oxygenated conditions.

14. The composite according to claim 1, wherein said torrefied biomass has been torrefied between about 240° to about 280° C. under non-oxygenated conditions.

15. The composite according to claim 1, wherein said torrefied biomass has been torrefied between about 260° under non-oxygenated conditions.

16. The composite according to claim 1, wherein said torrefied biomass has been torrefied between about 30 to about 180 minutes under non-oxygenated conditions.

17. The composite according to claim 1, wherein said torrefied biomass has been torrefied between about 30 to about 120 minutes under non-oxygenated conditions.

18. The composite according to claim 1, wherein said torrefied biomass has been torrefied between about 30 to about 60 minutes under non-oxygenated conditions.

19. The composite according to claim 1, wherein said torrefied biomass degrades between about 300° and about 400° C.

20. The composite according to claim 1, wherein said torrefied biomass degrades between from about 300° to about 375° C.

21. The composite according to claim 1, wherein said torrefied biomass has a particle size between about 1 to about 1000 microns.

22. The composite according to claim 1, wherein said torrefied biomass has a particle size between about 50 to about 200 microns.

23. The composite according to claim 1, wherein said torrefied biomass comprises from about 5 to about 40 percent of the total weight of said composite.

24. The composite according to claim 1, wherein said torrefied biomass comprises from about 10 to about 30 percent of the total weight of said composite.

25. The composite according to claim 1, wherein said composite is prepared by a process comprising melt-blending said plastic with said torrefied biomass via extrusion.

26. The composite according to claim 1, wherein said composite has a higher heat deflection temperature than a composite comprising plastic but no torrefied biomass.

27. The composite according to claim 1, wherein said composite has a higher yield strength than a composite comprising plastic but no torrefied biomass.

28. The composite according to claim 1, wherein said composite has a higher flexural modulus than a composite comprising plastic but no torrefied biomass.

29. The composite according to claim 1, wherein said composite is comprised of (a) virgin plastic and (b) torrefied biomass.
